(19) United States
(12) Patent Application Publication
(10) Pub. No.: US 2009/0202910 A1
(43) Pub. Date: Aug. 13, 2009

(54) Alkaline Batteries

(76) Inventors: David L. Anglin, Brookfield, CT (US); Alexander B. Shelekhin, Ridgefield, CT (US)

Correspondence Address: FISH & RICHARDSON P.C., P.O. BOX 1022, MINNEAPOLIS, MN, 55440-1022, US

(21) Appl. No.: 12/028,139

(22) Filed: Feb. 8, 2008

(51) Int. Cl. H01M 4/50; H01M 2/14; H01M 4/42; H01M 4/08

(52) U.S. Cl. 429/224; 429/246; 429/229

(57) ABSTRACT

Alkaline cells are provided that include a cathode that comprises expanded graphite. In some implementations, the cathode includes less than about 4% graphite by weight.

### TECHNICAL FIELD

This invention relates to alkaline batteries.

### BACKGROUND

Batteries are commonly used as electrical energy sources. A battery contains a negative electrode, typically called the anode, and a positive electrode, typically called the cathode. The anode contains an active material that can be oxidized. The cathode contains or consumes an active material that can be reduced. The anode active material is capable of reducing the cathode active material. A separator is disposed between the anode and cathode. These components are disposed in a metal can.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

There is a growing need to make batteries better suitable for high power application. Modern electronic devices such as cellular phones, digital cameras and toys, flash units, remote control toys, camcorders and high intensity lamps are examples of such high power applications. Such devices require high current drain rates of between about 0.5 and 2 Amp, typically between about 0.5 and 1.5 Amp. Correspondingly, they require operation at power demands between about 0.5 and 2 Watt. It is also desirable for batteries to have a long service life (or in the case of some applications, such as digital cameras, be able to deliver a large number of pulses of energy). Batteries have a predetermined internal volume, i.e., the internal volume of the metal can, which is dictated by the standard external geometry of the particular type of battery. This internal volume limits the amounts of actives that can be included in the anode and cathode, and thus the performance characteristics of the battery.

### SUMMARY

In general, the invention features batteries comprising an anode, a cathode, and a separator disposed between the anode and cathode, containing relatively low levels of carbon particles.

In one aspect, the invention features an alkaline cell comprising an anode, a cathode, comprising a cathode active material and carbon particles, wherein the concentration of carbon particles in the cathode is less than about 4% by weight, and a separator disposed between the cathode and the anode.

In some implementations, the alkaline cell may include one or more of the following features. The carbon particles comprise expanded graphite. The cathode is substantially free of natural graphite particles. For example, the cathode may include less than 0.5% by weight of natural graphite, and it is generally preferred that the cathode include no natural graphite. The concentration of carbon particles in the cathode is less than or equal to about 3.5% by weight, and may be less than or equal to 3.25% by weight. The cathode active material comprises EMD. The concentration of cathode active material is from about 89% to about 91%. The anode comprises zinc as an active material. At least a portion of the zinc is in the form of zinc particles having an average particle size of less than 175 microns. The cathode has a moisture level, measured at cell assembly, in the range of about 2.5% to about 5%. The cathode has a porosity of from about 22% to about 30%. The separator has a wet thickness of less than 0.30 mm. The separator has a basis weight of about 35 g/m² or less.

In another aspect, the invention features an alkaline cell comprising an anode, a cathode, comprising a cathode active material and expanded graphite particles, wherein the concentration of carbon particles in the cathode is less than about 3.5% by weight, and a separator disposed between the cathode and the anode.

This aspect may include any or all of the features described above with regard to the first aspect.

The invention also features methods of manufacturing a cathode for an alkaline cell. In one aspect, the invention features a method comprising mixing a cathode active material with expanded graphite, wherein the expanded graphite is provided in a concentration of less than 4% by weight.

In some implementations, the method further includes controlling the moisture level of the cathode so that the moisture level, measured at cell assembly, is in the range of about 2.5% to about 5%. The method may further include controlling the porosity of the cathode so that it is in the range of about 22% to about 30%. The method may also include any of the other features described herein.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 is a schematic diagram of a battery.

### DETAILED DESCRIPTION

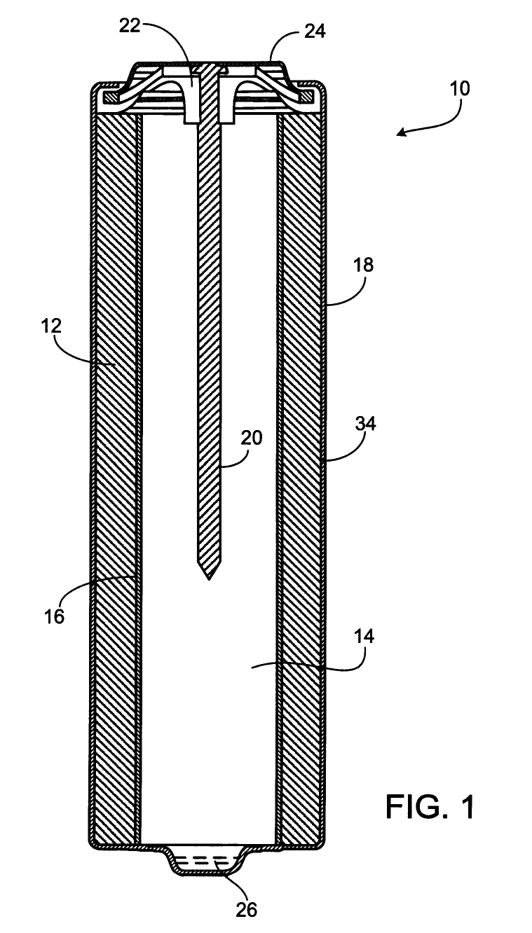

Referring to FIG. 1, battery 10 includes a cathode 12, an anode 14, a separator 16 and a cylindrical housing 18. Battery 10 also includes current collector 20, seal 22, and a negative metal end cap 24, which serves as the negative terminal for the battery. A positive pip 26, which serves the positive terminal of the battery, is at the opposite end of the battery from the negative terminal. An electrolytic solution is dispersed throughout battery 10. Battery 10 can be an alkaline battery, for example, an AA, AAA, AAAA, C, or D battery.

It is noted that the concentrations given below are for the cathode at the assembly step. As a result of moisture evaporation, the cathode is richer in actives and carbon at the assembly stage than it is when the ingredients are first mixed.

Cathode 12 includes one or more cathode active materials, carbon particles, and a binder. The cathode may also include other additives.

Examples of cathode active material include manganese dioxide, nickel oxyhydroxide, iron disulfide, silver oxide, or copper oxide.

A preferred cathode active material is manganese dioxide, having a purity of at least about 91 percent by weight. Electrolytic manganese dioxide (EMD) is a preferred form of manganese dioxide for electrochemical cells because of its high density and since it is conveniently obtained at high purity by electrolytic methods. Chemical manganese dioxide (CMD), a chemically synthesized manganese dioxide, has also been used as cathode active material in electrochemical cells including alkaline cells and heavy duty cells.

EMD is typically manufactured from direct electrolysis of a bath of manganese sulfate and sulfuric acid. Processes for the manufacture of EMD and its properties appear in Batteries, edited by Karl V. Kordesch, Marcel Dekker, Inc., New York, Vol. 1, (1974), p. 433-488. CMD is typically made by a process known in the art as the “Sedema process”, a chemical process disclosed by U.S. Pat. No. 2,956,860 (Welsh) for the manufacture of battery grade MnO₂ by employing the reaction mixture of MnSO₄ and an alkali metal chlorate, preferably NaClO₃. Distributors of manganese dioxides include Kerr McGee Co. (Trona D), Chem Metals Co., Tosoh, Delta Manganese, Mitsui Chemicals, JMC, and Xiangtan.

The carbon particles are included in the cathode to allow the electrons to distribute through the cathode. The carbon particles are of synthetic expanded graphite. The inventors have found that, by utilizing expanded graphite, the amount of carbon particles in the cathode can be significantly reduced, e.g., from the 5 to 9% by weight that is generally used in commercially available batteries, to less than 4% or even less than 3.5%. This reduction in the carbon level allows the cathode to include a higher level of active material without increasing the volume of the cell or reducing the void volume (which must be maintained at or above a certain level to prevent internal pressure from rising too high as gas is generated within the cell). Because the active material (e.g., EMD) has a higher density than the graphite, even a relatively small reduction in the graphite level allows a significant increase in the concentration of active material, which results in a significantly higher cell capacity. For example, a 1.75% decrease in graphite allows a 3.6% increase in EMD while maintaining the internal cell volume and void volume constant. Suitable expanded graphite particles can be obtained, for example, from Chuetsu Graphite Works, Ltd. (Chuetsu grades WH-20A and WH-20AF) of Japan or Timcal America (Westlake, Ohio, KS-Grade). Some preferred cells contain from about 3% to about 3.5% expanded graphite by weight. In some implementations, this allows the level of EMD to be from about 89% to 91% by weight as supplied. (EMD contains about 1-1.5% moisture as supplied, so this range equates to about 88% to 90% pure EMD.) Preferably, the ratio of cathode active material to expanded graphite is greater than 25, and more preferably greater than 26 or even greater than 27. In some implementations, the ratio is between 25 and 33, e.g., between 27 and 30. These ratios are determined by analysis, ignoring any water.

It is generally preferred that the cathode be substantially free of natural graphite. While natural graphite particles provide lubricity to the cathode forming equipment, this type of graphite is significantly less conductive than expanded graphite, and thus it is necessary to use more in order to obtain the same cathode conductivity. If necessary, the cathode may include low levels of natural graphite, however this will compromise the reduction in graphite concentration that can be obtained while maintaining a particular cathode conductivity.

The cathode may be provided in the form of pressed pellets. For optimal processing, it is generally preferred that the cathode have a moisture level in the range of about 2.5% to about 5%, more preferably about 2.8% to about 4.6%. It is also generally preferred that the cathode have a porosity of from about 22% to about 30%, for a good balance of manufacturability, energy density, and integrity of the cathode.

Examples of binders that may be used in the cathode include polyethylene, polyacrylic acid, or a fluorocarbon resin, such as PVDF or PTFE. An example of a polyethylene binder is sold under the trade name COATHYLENE HA-1681 (available from Hoechst or DuPont).

Examples of other additives are described in, for example, U.S. Pat. Nos. 5,698,315, 5,919,598, and 5,997,775 and U.S. application Ser. No. 10/765,569.

An electrolyte solution can be dispersed through cathode 12, and the weight percentages provided above and below are determined after addition of the electrolyte solution. The electrolyte can be an aqueous solution of alkali hydroxide, such as potassium hydroxide or sodium hydroxide. The electrolyte can also be an aqueous solution of saline electrolyte, such as zinc chloride, ammonium chloride, magnesium perchlorate, magnesium bromide, or their combinations.

Anode 14 can be formed of an anode active material, a gelling agent, and minor amounts of additives, such as gassing inhibitor. In addition, a portion of the electrolyte solution discussed above is dispersed throughout the anode.

Examples of the anode active material include zinc. Preferably, to compensate for the increased active material in the cathode, the anode active material includes zinc having a fine particle size, e.g., an average particle size of less than 175 microns. The use of this type of zinc in alkaline cells is described in U.S. Pat. No. 6,521,378, the complete disclosure of which is incorporated herein by reference.

Examples of a gelling agent can include a polyacrylic acid, a grafted starch material, a salt of a polyacrylic acid, a carboxymethylcellulose, a salt of a carboxymethylcellulose (e.g., sodium carboxymethylcellulose) or combinations thereof.

The anode may include a gassing inhibitor which can include an inorganic material, such as bismuth, tin, or indium. Alternatively, the gassing inhibitor can include an organic compound, such as a phosphate ester, an ionic surfactant or a nonionic surfactant.

Separator 16 can be a conventional alkaline battery separator. Preferably, the separator material is thin. For example, for an AA battery, the separator may have a wet thickness of less than 0.30 mm, preferably less than 0.20 mm and more preferably less than 0.10 mm, and a dry thickness of less than 0.10 mm, preferably less than 0.07 mm and more preferably less than 0.06 mm. The basis weight of the paper is generally in the range of about 20 to 80 g/m². In some preferred implementations the paper has a basis weight of 35 g/m² or less. In other embodiments, separators 16 and 42 can include a layer of cellophane combined with a layer of non-woven material. The separator also can include an additional layer of non-woven material.

Housing 18 can be a conventional housing commonly used in primary alkaline batteries, for example, nickel plated cold-rolled steel. Current collector 20 can be made from a suitable metal, such as brass. Seal 22 can be made, for example, of a polyamide (Nylon).

In some preferred implementations, the cells exhibit very good service life and cell capacity. For example, cells made with concentrations of 3.5%, 4.0%, and 4.4% expanded graphite by weight, keeping a constant volume of cell ingredients (anode+cathode+separator+KOH electrolyte) had the following 0.25 A 1 hour per day to a 0.9 volt cut-off performance: 9.63 hours/9.55 hours/9.37 hours. So the cells made with 3.5% graphite group, which as a result contained more actives (EMD and zinc), gave 2.8% more service hours. In another experiment, a cell containing 3.0% expanded graphite gave 9.99 service hours (+6.6% compared with the 4.4% expanded graphite group) using the same test (0.25A 1 hour per day to 0.9 volt cut-off).

A number of embodiments of the invention have been described. Nevertheless, it will be understood that various modifications may be made without departing from the spirit and scope of the invention.

For example, while we have discussed above increasing the amount of cathode active material, in many cases it will be desirable to also increase the amount of anode active material. In such cases, some of the extra volume that is freed up by using less graphite is used to increase the anode active material.

Accordingly, other embodiments are within the scope of the following claims.

What is claimed is:

1. An alkaline cell comprising:
an anode,
a cathode, comprising a cathode active material and carbon particles, wherein the concentration of carbon particles in the cathode is less than about 4% by weight, and
a separator disposed between the cathode and the anode.

2. The alkaline cell of claim 1 wherein the carbon particles comprise expanded graphite.

3. The alkaline cell of claim 1 wherein the cathode is substantially free of natural graphite particles.

4. The alkaline cell of claim 1 wherein the concentration of carbon particles in the cathode is less than or equal to about 3.5% by weight.

5. The alkaline cell of claim 1 wherein the concentration of carbon particles in the cathode is less than or equal to 3.25% by weight.

6. The alkaline cell of claim 1 wherein the cathode active material comprises EMD.

7. The alkaline cell of claim 1 wherein the concentration of cathode active material is from about 89% to about 91%.

8. The alkaline cell of claim 1 wherein the anode comprises zinc as an active material.

9. The alkaline cell of claim 8 wherein at least a portion of the zinc is in the form of zinc particles having an average particle size of less than 175 microns.

10. The alkaline cell of claim 1 wherein the cathode has a moisture level, at cell assembly, in the range of about 2.5% to about 5%.

11. The alkaline cell of claim 1 wherein the cathode has a porosity of from about 22% to about 30%.

12. The alkaline cell of claim 1 wherein the separator has a wet thickness of less than 0.30 mm.

13. The alkaline cell of claim 1 wherein the separator has a basis weight of about 35 g/m² or less.

14. An alkaline cell comprising:
an anode,
a cathode, comprising a cathode active material and expanded graphite particles, wherein the concentration of carbon particles in the cathode is less than about 3.5% by weight, and
a separator disposed between the cathode and the anode.

15. The alkaline cell of claim 14 wherein the cathode is substantially free of natural graphite particles.

16. The alkaline cell of claim 15 wherein the concentration of carbon particles in the cathode is less than or equal to 3.25% by weight.

17. The alkaline cell of claim 14 wherein the cathode active material comprises EMD.

18. The alkaline cell of claim 14 wherein the concentration of cathode active material is from about 89% to about 91%.

19. A method of manufacturing a cathode for an alkaline cell, the method comprising mixing a cathode active material with expanded graphite, wherein the expanded graphite is provided in a concentration of less than 4% by weight.

20. The method of claim 19 further comprising controlling the moisture level of the cathode so that the moisture level, measured at cell assembly, is in the range of about 2.5% to about 5%.

21. The method of claim 19 further comprising controlling the porosity of the cathode so that it is in the range of about 22% to about 30%.
